(19) United States
(12) Patent Application Publication
(10) Pub. No.: US 2023/0184075 A1
(43) Pub. Date: Jun. 15, 2023

(54) METHOD TO ACCELERATE ACID REACTIVITY DURING RESERVOIR STIMULATION

(71) Applicant: ARAMCO SERVICES COMPANY, Houston, TX (US)

(72) Inventors: Amy J. CAIRNS, Houston, TX (US); Frank F. CHANG, Houston, TX (US); Mohammed SAYED, Katy, TX (US)

(73) Assignee: ARAMCO SERVICES COMPANY, Houston, TX (US)

(21) Appl. No.: 18/046,351

(22) Filed: Oct. 13, 2022

Related U.S. Application Data
(60) Provisional application No. 63/265,423, filed on Dec. 15, 2021.

(51) Int. Cl. E21B 43/27; C09K 8/74; C09K 8/60

(52) U.S. Cl. CPC E21B 43/27; C09K 8/74; C09K 8/602

(57) ABSTRACT

Formation treatment compositions may include a surfactant and an aqueous acid solution or mixture. The surfactant may include one or more of C₆-C₂₀-fluoroalkylsulfonate, C₆-C₂₀-alkylarylsulfonate, C₆-C₂₀-alkylcycloalkylsulfonate, C₆-C₂₀-arylsulfate, C₆-C₂₀-alkylphosphonate, C₆-C₂₀-arylphosphonate, C₆-C₂₀-alkylpolyetherphosphate, C₆-C₂₀-alkylpolyetherphosphonate, C₆-C₂₀-alkylcarboxylate, C₆-C₂₀-arylcarboxylate, and polyoxyethyleneamine. In the formation treatment compositions, the surfactant may be configured to partially or fully adsorb on a carbonate formation to accelerate the partial dissolution of the formation. Methods of treating a formation may include introducing the formation treatment composition into a wellbore such that that the formation treatment composition contacts the formation.

### CROSS REFERENCE TO RELATED APPLICATIONS

This application claims priority to U.S. Provisional Pat. Application Ser. No. 63/265,423 filed on Dec. 15, 2021. These applications are incorporated by reference herein.

### BACKGROUND

In order to increase hydrocarbon production in carbonate formations, stimulation treatments are often performed with acids, such as inorganic acids, organic acids, or a combination of both. These acids may be selected based on their reactivity with the rock matrix in the carbonate formations. Matrix stimulation treatments may be performed by injecting these acids through wellbores to react with and dissolve parts of the carbonate formations. In successful treatments, the dissolution process results in the formation of highly conductive channel networks, thereby enhancing hydrocarbon production. Such acid stimulation may be carried out in formations including calcite, dolomite, and the like, using strong mineral acids. For instance, hydrochloric acid (HCl) may be chosen because of its low cost and effectiveness in dissolving calcium and magnesium carbonates. Moreover, the reaction products resulting from the dissolution are readily soluble in water, which may be advantageous in preventing damage to the formation.

However, reactions between conventional acids and dolomite-rich (CaMg(CO₃)₂) rock matrices generally proceed at slow rates, even at elevated temperatures. This may result in significant operational limitations in terms of performance or cost. For instance, the targeted differential etching pattern preventing loss of the flow channel upon closure of the fracture may be hindered. Other limitations may include the formation of uniform or bell-shaped etching patterns due to prolonged exposure of the acid with dolomite-rich rock matrices resulting in uneven conductivity along the length of the fracture. Additionally, extended shut-in times at the well site due to such longer reaction times may pose higher corrosion risks and increase the overall treatment cost as corrosion inhibitor packages will need to be added to the acid treatment. Further, such extended shut-in times may result in additional cost as the equipment must remain at the well site for longer periods of time.

### SUMMARY

Certain embodiments of the disclosure will be described with reference to the accompanying drawings, where like reference numerals denote like elements. It should be understood, however, that the accompanying figures illustrate the various implementations described and are not meant to limit the scope of various technologies described.

In one aspect, embodiments disclosed herein relate to a formation treatment composition. The formation treatment composition may include a surfactant comprising one or more of C₆-C₂₀-fluoroalkylsulfonate, C₆-C₂₀-alkylarylsulfonate, C₆-C₂₀-alkylcycloalkylsulfonate, C₆-C₂₀-arylsulfate, C₆-C₂₀-alkylphosphonate, C₆-C₂₀-arylphosphonate, C₆-C₂₀-alkylpolyetherphosphate, C₆-C₂₀-alkylpolyetherphosphonate, C₆-C₂₀-alkylcarboxylate, C₆-C₂₀-arylcarboxylate, and polyoxyethyleneamine. The formation treatment composition may also include an aqueous acid solution or mixture. In the formation treatment composition, the surfactant may be configured to partially or fully adsorb on a carbonate formation to accelerate the partial dissolution of the formation.

In another aspect, embodiments disclosed herein relate to a method of treating a formation treatment composition. The method may include introducing the formation treatment composition into a wellbore such that that the formation treatment composition contacts the formation.

Other aspects and advantages of this disclosure will be apparent from the following description made with reference to the accompanying drawings and the appended claims.

### BRIEF DESCRIPTION OF DRAWINGS

FIG. 1 is a graph representing the amount of calcium dissolved as a function of the time of exposure of an Indiana limestone core sample of to the acid formulation 1 of Table 1 allowing the determination of the corresponding reaction rate.

FIG. 2 is a graph representing the amount of calcium dissolved as a function of the time of exposure of an Indiana limestone core sample to the acid formulation 2 of Table 1 allowing the determination of the corresponding reaction rate.

FIG. 3 is a graph representing the amount of magnesium dissolved as a function of the time of exposure of a Silurian dolomite core sample to the acid formulation 8 of Table 2 allowing the determination of the corresponding reaction rate.

FIG. 4 is a graph representing the amount of magnesium dissolved as a function of the time of exposure of a Silurian dolomite core sample to the acid formulation 12 for NaDDBS (0.287 mmol) of Table 2 allowing the determination of the corresponding reaction rate.

FIG. 5 is a graph representing the amount of magnesium dissolved in function of the time of exposure of a Silurian dolomite core sample to the acid formulation 9 for KPFOS (0.287 mmol) of Table 2 allowing the determination of the corresponding reaction rate.

### DETAILED DESCRIPTION

Several strategies have been employed to promote acceleration of the reaction rate between acids and dolomite-rich rock matrices. For example, changes to the stimulation process, for example with respect to pumping volumes, injection rates, and shut-in times, have been implemented in attempt to improve the stimulation efficiency in such zones. However, despite these process changes, limitations still exist as the reaction rate remains slow in these conditions.

Accordingly, there exists a need for improved matrix acidization and stimulation treatments of dolomite-rich carbonate formations. Such treatments may provide a desirable etching pattern and result in an increased production from these zones.

One or more embodiments of the present disclosure relate to compositions and methods for increasing the reaction rate between an acid, such as HCl, and a carbonate formation material matrix through the addition of surfactant compounds, which may be anionic, cationic, non-ionic, zwitterionic, and combinations thereof. Specifically, one or more embodiments relate to aqueous treatments for downhole applications, including a surface-active ingredient containing an amphiphilic surfactant and an acid in an aqueous solution. The hydrophilic group of the surfactant bearing the head moiety is configured to adsorb onto the formation surface while the hydrophobic group bearing the tail moiety is directed outward.

The presence of a surfactant molecule with tail groups having high electronic charge density (such as fluoro- and/or aromatic moieties) in an aqueous composition containing an acid used for the production of hydrocarbons from carbonate formations, via a matrix acidizing or acid fracturing or formation treatment, may act as a accelerating agent that can effectively promote the electrostatic interactions between electron-rich substituents of the tail group and the dissociated protons of the acid (such as HCl). This may result in an increased concentration of the dissociated protons in the vicinity of the carbonate matrix and thus an increased reaction rate between acid and carbonate.

The surfactant may include one or more of C₆-C₂₀-fluoroalkylsulfonate, C₆-C₂₀-fluoroarylsulfonate, C₆-C₂₀-alkylarylsulfonate, C₆-C₂₀-alkylcycloalkylsulfonate, C₆-C₂₀-arylsulfate, C₆-C₂₀-alkylphosphonate, C₆-C₂₀-arylphosphonate, C₆-C₂₀-fluoroarylphosphonate, C₆-C₂₀-alkylpolyetherphosphate, C₆-C₂₀-alkylpolyetherphosphonate, C₆-C₂₀-alkylcarboxylate, C₆-C₂₀-arylcarboxylate, C₆-C₂₀-fluoroarylcarboxylate, polyoxyethyleneamine, and combinations thereof.

An alkyl group may be defined as a saturated hydrocarbon group, such as a C₆-C₂₀-alkyl group, that may be linear, branched, or cyclic, such as non-aromatic. Examples of such groups include, but are not limited to, hexyl, heptyl, octyl, nonyl, decyl, undecyl, dodecyl, cyclohexyl, cyclooctyl, including their substituted analogues. Substituted alkyl groups are groups in which at least one hydrogen atom of the alkyl group has been substituted with at least one functional group, such as F, Cl, Br, I, NR₂, OR, SeR, TeR, PR₂, AsR₂, SbR₂, SR, BR₂, SiR₃, GeR₃, SnR₃, and PbR₃, or where at least one heteroatom has been inserted within an aryl ring.

In some embodiments, the surfactant may be a zwitterion, defined as a molecule that contains an equal number of positively charged and negatively charged functional groups.

In some embodiments, the surfactants may include a hydrophilic head-group and a hydrophobic tail-group. The hydrophilic head-group may include a charged functional group, such as sulfonate group, phosphonate, or carboxylate group. The hydrophobic tail-group may include an alkyl group, a poly-alkylated aromatic, or an aromatic ring system, where each of these substituents may be branched or linear.

In some embodiments, the surfactant may include a metal sulfonate salt, such as an alkali metal sulfonate salt, an ammonium sulfonate salt, such as a primary ammonium sulfonate salt, a secondary ammonium sulfonate salt, or a tertiary ammonium sulfonate salt. In some embodiments, the surfactant may include sodium dodecylbenzenesulfonate, potassium perfluorooctanesulfonate, and combinations thereof.

In some embodiments, the surfactant hydrophilic head group may include a sulfonate and the surfactant hydrophobic tail group may include an alkyl group that may be substituted by one or more halogen groups and/or may be branched or linear. In some embodiments, the surfactant hydrophilic head group may include a sulfonate and the surfactant hydrophobic tail group may include a polyalkylated aromatic or non-aromatic ring system, where the alkyl substituents may be branched or linear and where the ring system may be further substituted by one or more halogen groups.

In some embodiments, the surfactant may be first dissolved in water to form an aqueous concentrate solution. The concentration of aqueous solution in the formation treatment may be in a range of 1% by weight to 50% by weight. In some embodiments, the surfactant may be added with an acidic solution in the formation treatment so that the surfactant is in an amount sub-stoichiometric compared to the acid. In some embodiments, the surfactant may be added with an acidic solution in the formation treatment so that the surfactant is present in the formation treatment at a concentration of up to 20 gallons per 1000 gallons (gpt) of formation treatment, such as in a range of from about 0.01 gpt to about 20 gpt, from about 0.05 gpt to about 15 gpt, from about 0.1 gpt to about 10 gpt, from about 0.2 gpt to about 5 gpt, from about 0.3 gpt to about 3 gpt, and from about 0.5 gpt to about 2 gpt. In some embodiments, the formation treatment may be added to formations having fractures extending from tens to several hundreds of feet.

In some embodiments, the surfactant may be added with an acidic solution in the formation treatment so that the surfactant is present in the formation treatment at a concentration of up to 0.011 mole per liter (M) of formation treatment, such as in a range of from about 0.0001 M to about 0.011 M, from about 0.0002 M to about 0.011 M, from about 0.0003 M to about 0.011 M, from about 0.0005 M to about 0.011 M, from about 0.001 M to about 0.011 M, and from about 0.002 M to about 0.011 M. In some embodiments, the surfactant may be added with an acidic solution in the formation treatment so that the surfactant is present in the formation treatment at a concentration of from about 1 to about 60 pounds per thousand gallons (pptg) of formation treatment.

When introduced into a wellbore, the surfactants that include a hydrophilic head-group and a hydrophobic tail-group may adhere to the rock surface via surface adsorption resulting from the coordination of the hydrophilic head-groups with the rock surface. The tail-groups may therefore be directed outward. The tail-groups can induce an electronic charge density character in the vicinity of the rock surface. This electronic charge density character may promote the concentration of dissociated protons from the acid near the formation surface. The acid therefore may react at a higher rate with the carbonate of the formation.

In some embodiments, the surfactant may be functionalized to promote electronic charge density on the tail end, for example, by introducing a greater number of aromatic, or halo-substituted alkyl moieties on the surfactants molecule tail end. The resulting more highly electronically dense surfactant molecules in the vicinity of the rock surface may provide an enhanced interaction with acidic protons of a formation treatment aqueous solution, which may in turn result in an enhanced reactivity of these protons with the carbonate.

In some embodiments, the surfactants may be combined with suitable inorganic or organic acids or acid-producing systems as a means of tailoring the acid reactivity with the rock matrix. In some embodiments, the formation treatments of the present disclosure may incorporate an acid in an aqueous solution. The acid may include an inorganic acid, an organic acid, or both. The inorganic acid may include, but are not limited to, HCl, nitric acid, phosphoric acid, hydrofluoric acid, hydrobromic acid, perchloric acid, fluoroboric acid, or derivatives, and mixtures thereof. The organic acid may include, but are not limited to, formic acid, acetic acid, citric acid, lactic acid, sulfamic acid, chloroacetic acid, or derivatives, and mixtures thereof. Acid-producing systems may include, but are not limited to, esters, lactones, anhydrides, orthoesters, polyesters or polyorthoesters. The acid-producing systems may include esters of short chain carboxylic acids, including, but not limited to, acetic and formic acid, and esters of hydroxycarboxylic acids, including, but not limited to, glycolic and lactic acid. These acid-producing systems may provide the corresponding acids when hydrolyzed in the presence of water. The acid may be present in an aqueous composition at a concentration in a range of from about 5 wt% to about 35 wt%, such as from about 7 wt% to about 32 wt%, from about 10 wt% to about 30 wt%, from about 15 wt% to about 28 wt%, from about 20 wt% to about 28 wt%, from about 25 wt% to about 28 wt%, and from about 26 wt% to about 28 wt% (weight percent).

Formation treatments described in this disclosure may optionally comprise one or more additives, for example, to improve the compatibility of the fluids described in this application with other fluids (for instance, formation fluids) that may be present in the well bore. Suitable additives may be used in liquid or powder form. Where used, additives are present in the fluids in an amount sufficient to prevent incompatibility with formation fluids or well bore fluids. If included, additives may be in a range of from about 0.01% to about 10% vol% (volume percent) of the total formation treatment. In some embodiments, where powdered additives are used, the additives may be present in an amount in the range of from about 0.001 wt% to about 10 wt% of the total formation treatment.

In some embodiments, additives to the formation treatments may include non-emulsifiers. In some embodiments, these may include non-emulsifiers commercially available from Halliburton Energy Services, Inc., of Duncan, Oklahoma, under the tradenames “LOSURF-259™” nonionic nonemulsifier, “LOSURF-300™” nonionic surfactant, “LOSURF-357™” nonionic surfactant, and “LOSURF-400™” surfactant. Additional non-emulsifier may include “NEA-96M™” surfactant, which is also commercially available from Halliburton Energy Services, Inc., of Duncan, Oklahoma. In some embodiments, these additives may be added to a viscosified fluid of a composition as described in this application as that fluid is being pumped down hole to help eliminate the possibility of foaming if so desired.

In some embodiments, mutual solvents may be employed in the formation treatments. Mutual solvents may help keep other additives in solution. Suitable mutual solvents may include, but are not limited to, MUSOL® Mutual Solvent, MUSOL® A Mutual Solvent, MUSOL® E Mutual Solvent, which are commercially available from Halliburton Energy Services, Inc., of Duncan, Oklahoma as well as ethyleneglycolmonobutylether, propyleneglycolmonobutylether, water, methanol, isopropyl alcohol, alcohol ethers, aromatic solvents, other hydrocarbons, mineral oils, paraffins, derivatives thereof, and combinations thereof. Other suitable solvents may also be used. If used, the mutual solvent may be included in a range of from about 1 vol% to about 20 vol%, and in certain embodiments in a range of from about 5 vol% to about 10 vol% based on the of the total volume of the formation treatment.

In one or more embodiments, the formation treatments may optionally include one or more bactericides. Bactericides protect both the subterranean formation as well as the fluid from attack by bacteria. Such attacks may be problematic because they may reduce the viscosity of the fluid, resulting in poorer performance, for example. Bacteria may also cause plugging by bacterial slime production and can turn the oil in the formation sour. Any bactericides known in the art are suitable. An artisan of ordinary skill with the benefit of this disclosure will be able to identify a suitable bactericide and the proper concentration of such bactericide for a given application. Where used, such bactericides may be present in an amount sufficient to destroy all bacteria that may be present. Examples of suitable bactericides include, but are not limited to, 2,2-dibromo-3-nitrilopropionamide and 2-bromo-2-nitro-1,3-propanediol. In one embodiment, the bactericides may be present in the formation treatment in an amount in the range of from about 0.001 wt% to about 0.003 wt% based on the total weight of the formation treatment. Another example of a suitable bactericide is a solution of sodium hypochlorite. In certain embodiments, such bactericides may be present in the formation treatments in an amount in the range of from about 0.01 vol% to about 0.1 vol% based on the total volume of the formation treatment.

In one or more embodiments, the formation treatments may optionally include additional additives. Examples of such additional additives may include, but are not limited to, corrosion inhibitors, corrosion inhibitors intensifiers, friction reducers, iron control additives, non-emulsification agents, anti-sludging agents, pH-adjusting agents, pH-buffers, oxidizing agents, enzymes, lost circulation materials, scale inhibitors, surfactants, clay stabilizers, paraffin inhibitors, asphaltene inhibitors, penetrating agents, clay control additives, reducers, oxygen scavengers, sulfide scavengers, emulsifiers, foamers, gases, derivatives thereof, and combinations thereof.

In some embodiments, the formation treatments may optionally include additional additives, such as a foamer. Examples of foamers include, but are not limited to, surfactants, for example, water-soluble, nonionic, anionic, cationic, and amphoteric surfactants; carbohydrates, for example, polysaccharides, cellulosic derivatives, guar, guar derivatives, xanthan, carrageenan, starch polymers, gums, polyacrylamides, polyacrylates, betaine-based surfactants, viscoelastic surfactants, natural and synthetic clays; polymeric surfactants, for example, partially hydrolyzed polyvinyl acetate; partially hydrolyzed modified polyvinyl acetate; block or copolymers of polyethylene, polypropylene, polybutylene and polypentene; proteins; partially hydrolyzed polyvinyl acetate, polyacrylate, and derivatives of polyacrylates; polyvinyl pyrrolidone and derivatives thereof; N₂; CO; CO₂; air; and natural gas; and combinations thereof.

In some embodiments, the present disclosure relates to methods of treating a formation, comprising introducing into a wellbore a formation treatment containing a surfactant comprising one or more of C₆-C₂₀-fluoroalkylsulfonate, C₆-C₂₀-alkylarylsulfonate, C₆-C₂₀-alkylcycloalkylsulfonate, C₆-C₂₀-arylsulfate, C₆-C₂₀-alkylphosphonate, C₆-C₂₀-arylphosphonate, C₆-C₂₀-alkylpolyetherphosphate, C₆-C₂₀-alkylpolyetherphosphonate, C₆-C₂₀-alkylcarboxylate, C₆-C₂₀-arylcarboxylate, and polyoxyethyleneamine; and an aqueous acid solution or mixture, such that that the formation treatment contacts the formation, and where the surfactant is configured to partially or fully adsorb on a carbonate formation to accelerate the partial dissolution of the formation. These methods accelerate the reaction rate between acid and the rock matrix (calcite- or dolomite-rich matrix) through the addition of surfactant molecules. These surfactants may be added to an acidic media at low concentrations, for example, up to about 20 gpt, such as in a range of from about 0.01 gpt to about 20 gpt, from about 0.05 gpt to about 20 gpt, from about 0.1 gpt to about 20 gpt, from about 0.2 gpt to about 20 gpt, from about 0.3 gpt to about 20 gpt, and from about 0.5 gpt to about 20 gpt. In some embodiments, these surfactants may be added to an acidic solution in the formation treatment so that the surfactants are present in the formation treatment at a concentration of up to 0.011 mole per liter (M) of formation treatment, such as in a range of from about 0.0001 M to about 0.011 M, from about 0.0002 M to about 0.011 M, from about 0.0003 M to about 0.011 M, from about 0.0005 M to about 0.011 M, from about 0.001 M to about 0.011 M, and from about 0.002 M to about 0.011 M.

In some embodiments, the step of contacting comprises introducing the aqueous solution into the formation via coiled tubing or bullheading in a production tube.

In some embodiments, the methods may further include the step of combining an aqueous solution of the surfactant and the aqueous solution of acid prior to introducing the formation treatment into the wellbore.

In some embodiments, in these methods, the step of contacting may include introducing an aqueous solution of the acid and an aqueous solution of the surfactant into the formation via the same tubing (for example, the same coiled tubing) and allowing the aqueous formation treatment to form in situ within the tubing, within the formation, or within the area around the wellbore.

In some embodiments, in these methods, the step of contacting may include introducing an aqueous solution of surfactant and the aqueous acidic solution into the formation in separate stages, optionally via the same or different tubings, such as the same or different coiled tubings, and allowing the aqueous fluids to mix within the formation. In some embodiments, the aqueous solution of the surfactant may be introduced into the formation first. In some embodiments, the acidic solution/stimulation fluid may be introduced into the formation first.

In some embodiments, in these methods, the formation treatment is in contact with the formation for a time ranging from about 1 minute to about 12 hours, or from about 2 minutes to about 11 hours, or from about 5 minutes to about 10 hours, or from about 10 minutes to about 7 hours, or from about 20 minutes to about 5 hours.

In some embodiments, the methods may further include producing hydrocarbons from the carbonate formation, which contain highly conductive channel networks formed by the accelerated action of the acid solution within the formation.

### EXAMPLES

The following examples are merely illustrative and should not be interpreted as limiting the scope of the present disclosure.

### Example 1 - Core-Plug Dissolution Experiments on Calcite and Dolomite

A series of core-plug dissolution experiments was performed using HCl with and without surfactants. The surfactants, when used, were at varying concentrations. Tables 1 and 2 provide the experimental details showing the dissolution profiles of this series of acid formulations for calcite (Table 1) and dolomite (Table 2) core samples. The testing conditions included ambient pressure and temperature, fluid volume of 250 milliliters (mL) and exposure times of 5 minutes (calcite) and 20 minutes (dolomite). The variability in time was to account for the slower reaction in the case of the latter.

The acid formulations were prepared by preparing HCl solutions with or without surfactants. Surfactants were first dissolved in deionized water (DI-H₂O). A predetermined volume of concentrated HCl (36 wt%) was then added to the aqueous phase to yield 28 wt% HCl.

In a typical experiment, the following steps were performed. Homogenous Indiana limestone core samples (Table 1) or Silurian dolomite core samples (Table 2) having a permeability between 4 to 8 millidarcy (mD) were cut to have a diameter and length of 1.5 inch (“) D x 0.5” L, respectively. One core sample was used for each individual test. The cores were dried in the oven at 248° F. (°F) overnight. Each of the dried cores were then saturated in deionized H₂O (DI-H₂O) under vacuum for 12 to 24 hours. The dry and saturated weight for the pre-treated cores were recorded and porosity was calculated. The acid formulations were prepared according to the details listed in Tables 1 and 2. Each saturated core was transferred to a 500 mL beaker containing 250 milliliters (mL) of each acid formulation. For each experiment, the core sample was placed standing up in the solution to ensure consistency across the series. The weight of each of the saturated acidized core samples was measured for both the dry and saturated sample. The percent of the weight loss for each core was calculated and compared. Additionally, for each test, the amount of dissolved calcite (CaCO₃) was calculated using Inductively Coupled Plasma Optical Emission Spectrometry (ICP-OES) measurements by determining the calcium concentration detected from an aliquot of the reaction.

Table 1 provides the calculated weight loss of Indiana limestone core samples, post-acidizing, for acid formulations containing the sole acid, at 28 wt% HCl, and formulations containing acid solutions at 28 wt% HCl in the presence of potassium perfluorooctanesulfonate, sodium dodecylbenzenesulfonate, sodium octanesulfonate, and sodium trifluoromethanesulfonate surfactants.

TABLE 1

| Formulation | HCl (wt%) | Surfactant | Surfactant Concentration (millimoles (mmol)/molarity (mol/L) | Calcite Dissolved (wt%) (weight loss/ ICP) |
|---|---|---|---|---|
| 1 | 28 | N/A | 0 | 76.3/75.4 |
| 2 | 28 | KPFOS¹ | 2.87 / 0.011 | 97.6/91.0 |
| 3 | 28 | NaDDBS² | 0.287 /0.001 | 92.7/89.7 |
| 4 | 28 | NaDDBS | 1.47 / 0.006 | 90.2 / 86.5 |
| 5 | 28 | NaDDBS | 2.87/ 0.011 | 86.5 / N.R.5 |
| 6 | 28 | NaOS³ | 2.87 / 0.011 | 71.4 / 61.1 |
| 7 | 28 | NaTFMS⁴ | 2.87 / 0.011 | 71.8/59.8 |

¹ Potassium perfluorooctanesulfonate.
² Sodium dodecylbenzenesulfonate.
³ Sodium octanesulfonate.
⁴ Sodium trifluoromethanesulfonate.
⁵ Not recorded.

The data provided in Table 1 show that the formulations including potassium perfluorooctanesulfonate and sodium dodecylbenzenesulfonate surfactants resulted in an unexpected increased acid-rock reactivity.

Table 2 provides the calculated weight loss of Silurian dolomite core samples, post-acidizing, for acid formulations containing acid solutions at 28 wt% HCl in the presence of potassium perfluorooctanesulfonate, sodium dodecylbenzenesulfonate, ammonium tosylate, ammonium triflate, and ammonium perfluorobutanesulfonate surfactants.

TABLE 2

| Formulation | HCl (wt%) | Surfactant | Surfactant Concentration (millimoles (mmol)/molarity (mol/L)) | Dolomite Dissolved (wt%) (weight loss) |
|---|---|---|---|---|
| 8 | 28 | None | 0 | 64.1 |
| 9 | 28 | KPFOS¹ | 0.287 / 0.0011 | 69.4 |
| 10 | 28 | KPFOS | 1.44 / 0.0058 | 72.2 |
| 11 | 28 | KPFOS | 2.87 / 0.011 | 37.7 |
| 12 | 28 | NaDDBS² | 0.287 / 0.0011 | 55.0 |
| 13 | 28 | NH₄TOS⁶ | 0.287 / 0.0011 | 61.2 |
| 14 | 28 | NH₄TF⁷ | 1.00/ 0.004 | 66.5 |
| 15 | 28 | NH₄PFBS⁸ | 0.287 / 0.011 | 58.03 |
| 16 | 28 | NH₄PFBS | 1.00/ 0.004 | 53.2 |

¹ Potassium perfluorooctanesulfonate.
² Sodium dodecylbenzenesulfonate.
⁶ Ammonium tosylate.
⁷ Ammonium triflate.
⁸ Ammonium perfluorobutanesulfonate.

The data provided in Table 2 show that the acceleration effects were also observed in dolomite using an acid formulation with potassium perfluorooctanesulfonate surfactant. In particular, a 28 wt% HCl stock solution containing 0.0058 M potassium perfluorooctanesulfonate was the optimal concentration to accelerate this reaction leading to a 12.5% increase in the dissolution under an exposure time of 20 min.

### Example 2 - Reaction Kinetics Evaluation in Reservoir Conditions on Calcite

The accelerated reactivity observed under ambient test conditions for potassium perfluorooctanesulfonate (0.011 M) (Formulation 2 - Table 1) under reservoir conditions was evaluated by reaction kinetics testing performed at 300° F. and 3000 psi using a custom-designed Rotating Disk Apparatus (RDA).

The reaction rate was determined for 28 wt% HCl in the presence of 0.011 M potassium perfluorooctanesulfonate at a constant disk speed of 500 RPM and compared to 28 wt% HCl in the absence of this surfactant. Outcrop Indiana limestone core with permeability from 2.0 to 6.0 md and porosities from 14.5 to 16.0% was used. Effluent samples were collected from the reactor in 25 seconds (s) intervals, after which the dissolution rate was determined by plotting the moles of calcium liberated as a function of time.

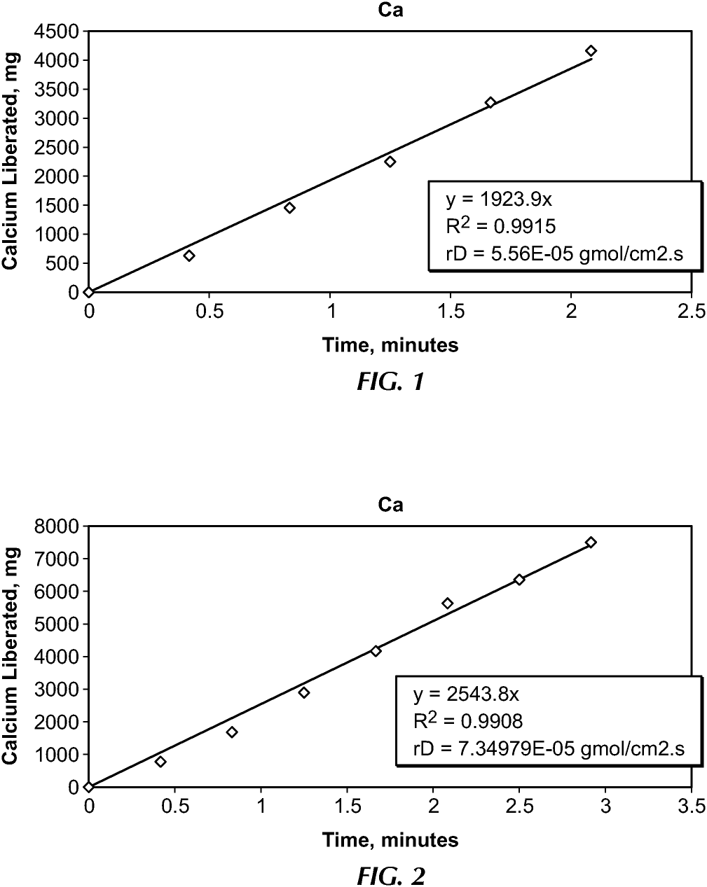

From the graphs of FIGS. 1 and 2, the reaction rate for 28 wt% HCl containing potassium perfluorooctanesulfonate was determined to be about 24% higher as compared to 28 wt% HCl without the surfactant. This was in good agreement with the calcite dissolution results obtained under ambient conditions which revealed an increase of 21.3 % and 15.6%, based on weight loss and ICP data, respectively.

### Example 3 - Reaction Kinetics Evaluation in Reservoir Conditions on Dolomite

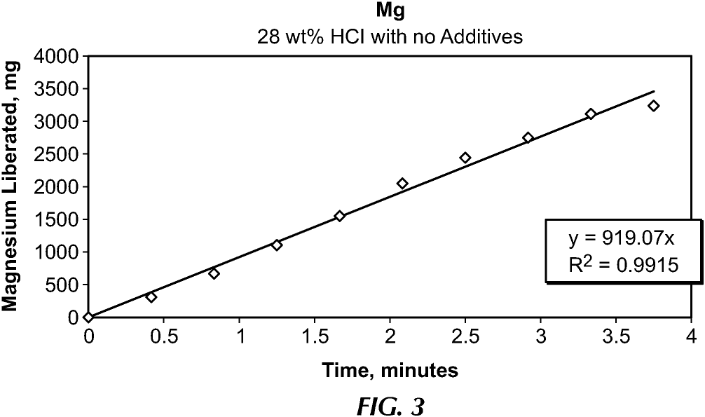

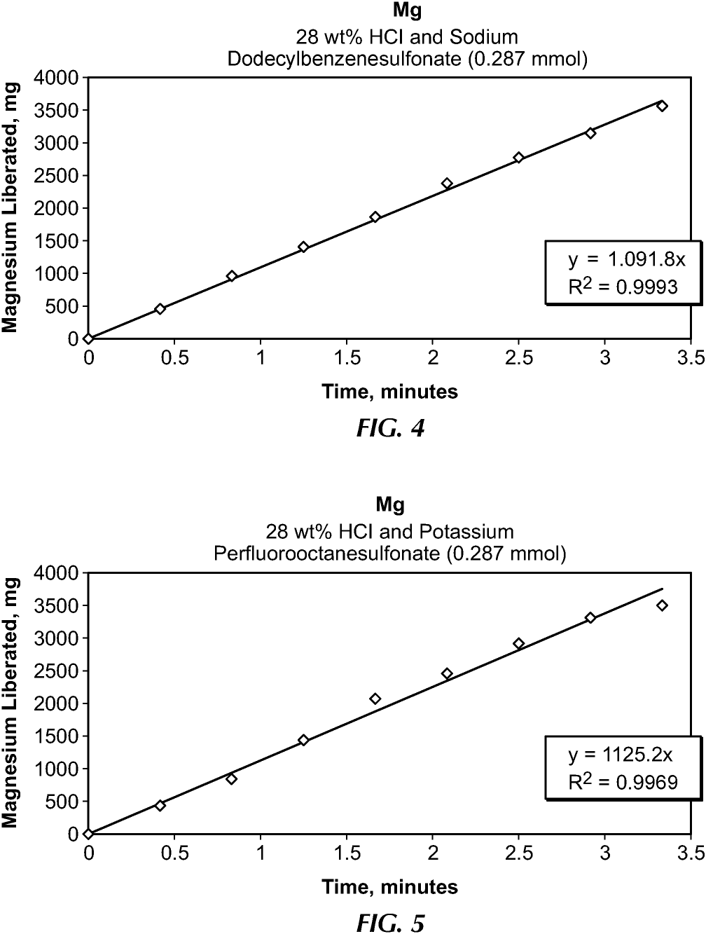

The impact of the potassium perfluorooctanesulfonate and sodium dodecylbenzenesulfonate on the reactivity of dolomite with 28 wt% HCl are shown in FIGS. 3-5. From the graphs of FIGS. 3-5, the reaction rates for 28 wt% HCl containing potassium perfluorooctanesulfonate and sodium dodecylbenzenesulfonate were determined to be about 32 and 25%, respectively, higher than the reaction rate for 28 wt% HCl without the surfactant.

While only a limited number of embodiments have been described, those skilled in the art having benefit of this disclosure will appreciate that other embodiments can be devised which do not depart from the scope of the disclosure.

Although the preceding description has been described here with reference to particular means, materials and embodiments, it is not intended to be limited to the particulars disclosed here; rather, it extends to all functionally equivalent structures, methods and uses, such as those within the scope of the appended claims.

The presently disclosed methods and compositions may suitably comprise, consist or consist essentially of the elements disclosed and may be practiced in the absence of an element not disclosed. For example, those skilled in the art can recognize that certain steps can be combined into a single step.

Unless defined otherwise, all technical and scientific terms used have the same meaning as commonly understood by one of ordinary skill in the art to which these systems, apparatuses, methods, processes and compositions belong.

The ranges of this disclosure may be expressed in the disclosure as from about one particular value, to about another particular value, or both. When such a range is expressed, it is to be understood that another embodiment is from the one particular value, to the other particular value, or both, along with all combinations within this range.

The singular forms “a,” “an,” and “the” include plural referents, unless the context clearly dictates otherwise.

As used here and in the appended claims, the words “comprise,” “has,” and “include” and all grammatical variations thereof are each intended to have an open, nonlimiting meaning that does not exclude additional elements or steps.

“Optionally” or “optional” mean that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

1. A formation treatment composition, comprising:
a. a surfactant comprising one or more of C₆-C₂₀-fluoroalkylsulfonate, C₆-C₂₀-alkylarylsulfonate, C₆-C₂₀-alkylcycloalkylsulfonate, C₆-C₂₀-arylsulfate, C₆-C₂₀-alkylphosphonate, C₆-C₂₀-arylphosphonate, C₆-C₂₀-alkylpolyetherphosphate, C₆-C₂₀-alkylpolyetherphosphonate, C₆-C₂₀-alkylcarboxylate, C₆-C₂₀-arylcarboxylate, and polyoxyethyleneamine; and
b. an aqueous acid solution or mixture;
where the surfactant is configured to partially or fully adsorb on a carbonate formation to accelerate the partial dissolution of the formation.

2. The formation treatment composition of claim 1, where the surfactant comprises linear alkyl substituents.

3. The formation treatment composition of claim 1, where the surfactant comprises branched fluoroalkyl or branched alkylaryl substituents.

4. The formation treatment composition of claim 1, where the surfactant comprises sodium dodecylbenzenesulfonate.

5. The formation treatment composition of claim 1, where the surfactant comprises potassium perfluorooctanesulfonate.

6. The formation treatment composition of claim 1, where the surfactant is present in a concentration in a range of up to about 0.011 mole per liter (M).

7. The formation treatment composition of claim 1, where the surfactant is present in a concentration in a range of about 1 to about 60 parts per trillion (pptg).

8. The formation treatment composition of claim 1, where the aqueous acid solution or mixture comprises an acid selected from the group consisting of an organic acid, and inorganic acid, and combinations thereof.

9. The formation treatment composition of claim 8, where the acid comprises hydrochloric acid, nitric acid, phosphoric acid, hydrofluoric acid, hydrobromic acid, perchloric acid, fluoroboric acid, formic acid, acetic acid, citric acid, lactic acid, sulfamic acid, chloroacetic acid, derivatives, or mixtures thereof.

10. The formation treatment composition of claim 1, where the aqueous acid solution or mixture comprises an acid present at a concentration of from about 5 wt% to 35 wt% based on the total weight of the formation treatment.

11. The formation treatment composition of claim 1 further comprising one or more additives selected from the group consisting of, corrosion inhibitors, corrosion inhibitors intensifiers, friction reducers, iron control additives, non-emulsification agents, anti-sludging agents, derivatives thereof, and combinations thereof.

12. The formation treatment composition of claim 1 further comprising one or more mutual solvents.

13. A method of treating a formation, comprising:
introducing the formation treatment composition of claim 1 into a wellbore such that that the formation treatment composition contacts the formation.

14. The method of claim 13, further comprising:
combining the surfactant and the aqueous acid solution or mixture prior to introducing the formation treatment composition into the wellbore.

15. The method of claim 13, where introducing the formation treatment composition into a wellbore comprises:
introducing an aqueous solution of the surfactant and the aqueous acid solution or mixture simultaneously in a same tubing, and
allowing the formation treatment to form in situ within the tubing, or within the formation.

16. The method of claim 13, where introducing the formation treatment into a wellbore comprises:
introducing an aqueous solution of the surfactant and the aqueous solution of acid in different tubings, and
allowing the formation treatment to form in situ within the formation.

17. The method of claim 13, where introducing the formation treatment composition into a wellbore comprises:
introducing an aqueous solution of the surfactant and the aqueous solution of acid consecutively, and
allowing the formation treatment to form in situ within the formation.

18. The method of claim 17, where the surfactant is introducing first into the wellbore.

19. The method of claim 13, where the formation treatment composition is introduced into the wellbore via coiled tubing or bullheading in a production tube.

20. The method of claim 13, where the formation treatment composition is in contact with the formation for a time ranging from about 1 minute to about 12 hours.
